(19) United States
(12) Patent Application Publication
(10) Pub. No.: US 2014/0080579 A1
(43) Pub. Date: Mar. 20, 2014

(54) Rewarding Player Referrals in a Wagering Game

(71) Applicant: WMS GAMING, INC., Waukegan, IL (US)

(72) Inventors: Thomas Abouchar, Atlanta, GA (US); Andrew Christian Guinn, Chicago, IL (US); Richard B. Robbins, Glenview, IL (US); Daniel Louie, Chicago, IL (US)

(73) Assignee: WMS GAMING, INC., Waukegan, IL (US)

(21) Appl. No.: 13/776,795

(22) Filed: Feb. 26, 2013

Related U.S. Application Data
(60) Provisional application No. 61/701,987, filed on Sep. 17, 2012.

(51) Int. Cl. G07F 17/32

(52) U.S. Cl. CPC G07F 17/3255
USPC 463/25

(57) ABSTRACT

Existing and/or new registrants for a wagering game may be selected as qualified participants in a referral award game. The referral award game may include determining a referral award game trigger for initiating the referral award game. A draw may be conducted during which a referral award is randomly assigned to each qualified participant. The referral award may include a value component usable in at least one of the wagering game or a secondary game. Each of the wagering game, referral award game, and secondary game may be conducted in a casino game format or social game format. Information regarding the referral award may be communicated to each qualified participant.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates generally to gaming apparatus and methods and, more particularly, to systems and methods for rewarding player referrals in wagering games.

### BACKGROUND OF THE DISCLOSURE

Casino game machines, such as slot machines, video poker machines, and the like, have been a cornerstone of the gaming industry for several years. Traditionally, casino game machines have been confined to physical structures, such as land- or water-based casinos (e.g., resort casinos, road-side casinos, casino boats, etc.). Casinos are located in specific geographical locations that are authorized to present wagering games to casino patrons. The proliferation of interest and use of a global public network (such as the Internet), however, potentially expands access to casino games to locations outside of the physical casino structures. Consequently, any individual with a personal computing device (e.g., a personal computer, a laptop, a personal digital assistant, a mobile phone, etc.) can connect to the Internet and process casino games. Consequently, some casino game manufacturers have created casino games that can be processed by personal computing devices and offered via online casino websites (“online casinos”). Several challenges, however, confront the development and operation of online casinos. For example, online casinos have struggled to provide the excitement and entertainment found in real world casino environments. Some online casinos have found it difficult to enforce cross-jurisdictional restrictions and requirements. Further, some online casinos have struggled to adapt the online gaming industry to a traditionally non-wagering game business environment. Consequently, casino game manufacturers, casino operators, and online game providers are confronted with various challenges to making the online gaming industry appealing and profitable.

### SUMMARY OF THE DISCLOSURE

Referrals between players in a wagering game may be rewarded with an entry in a referral award game. According to one aspect of the disclosure, a computer-implemented method of rewarding player referrals in a wagering game may include registering a new registrant for a wagering game through one or more input devices of a computational device. In response to determining that a referral was made to the new registrant by an existing registrant, the new registrant may be designated as a referred registrant and the existing registrant may be designated as a referring registrant. At least one of the referred registrant and the referring registrant may be selected as a qualified participant for a referral award game. The referral award game may be conducted for the at least one qualified participant by determining a referral award game trigger for initiating the referral award game, conducting a draw in which a referral award is randomly assigned to each qualified participant, the referral award including a value component usable in at least one of the wagering game and a secondary game, and communicating referral award information to the at least one qualified participant.

According to another aspect of the disclosure, a gaming system having a processor, a memory, in communication with the processor, a display, and an input/output circuit, where the processor is physically configured according to computer executable instructions for rewarding player referrals in a wagering game. The computer executable instructions may include instructions for registering a new registrant for a wagering game through one or more input devices of a computational device. In response to determining that a referral was made to the new registrant by an existing registrant, the new registrant may be designated as a referred registrant and the existing registrant may be designated as a referring registrant. At least one of the referred registrant and the referring registrant may be selected as a qualified participant for a referral award game. The referral award game may be conducted for the at least one qualified participant by determining a referral award game trigger for initiating the referral award game, conducting a draw in which a referral award is randomly assigned to each qualified participant, the referral award including a value component usable in at least one of the wagering game and a secondary game, and communicating referral award information to the at least one qualified participant.

According to yet another aspect of the present disclosure, a tangible machine-readable storage media includes instructions which, when executed by one or more processors, cause the one or more processors to perform the above methods.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic illustration of a gaming system according to an embodiment of the present disclosure.

FIG. 2 is a schematic illustration of an online gaming server usable in the gaming system of FIG. 1.

FIG. 3 is a schematic illustration of a computational device usable in the gaming system of FIG. 1.

FIG. 4a is a perspective view of a free-standing gaming machine usable in the gaming system of FIG. 1.

FIG. 4b is a schematic illustration of architecture for the gaming machine of FIG. 4a.

FIG. 5 is a perspective view of a handheld gaming machine usable in the gaming system of FIG. 1.

FIG. 6a is an image of an exemplary registration interface for a gaming service displayed on an output device of a client, according to an embodiment of the present disclosure.

FIG. 6b is an image of an exemplary gameplay interface for a gaming service displayed on an output device of a client, according to an embodiment of the present disclosure.

FIG. 7 is an illustration of a manner of selecting qualified participants for a referral award game and conducting the referral award game.

FIG. 8 is an illustration of a manner of conducting a referral award game.

FIG. 9 is an illustration of a display of a format for a referral award game.

While the claimed subject matter is susceptible to various modifications and alternative forms, specific embodiments have been shown by way of example in the drawings and will be described in detail herein. It should be understood, however, that the claimed subject matter is not intended to be limited to the particular forms disclosed. Rather, the intention is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill In some embodiments, the wagering game may involve wagers of real money, as found with typical land-based or on-line casino game formats. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

### Overall Network

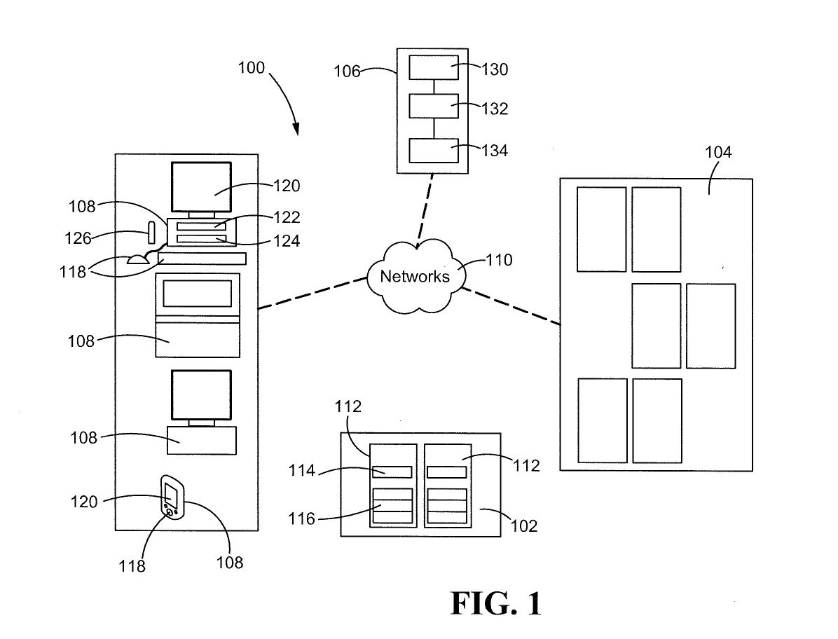

Referring to FIG. 1, one exemplary embodiment of a gaming system 100 is provided. In general, the gaming system 100 may be used to manage and/or facilitate certain interactions between gaming service providers, players or registrants of games provided by the gaming service providers, as well as social and/or virtual communities with which the players or registrants may be affiliated, associated and/or registered. As shown, the gaming system 100 includes at least one or more gaming servers 102, one or more community servers 104, one or more account servers 106, and one or more client devices 108, as well as one or more networks 110 electronically communicating information between each of the gaming servers 102, community servers 104, account servers 106, and clients 108. More specifically, the one or more networks 110 enable users or registrants at the client devices 108 to access gaming services from the gaming servers 102, social networks and/or virtual communities from the community servers 104, and account services from the account servers 106.

While each component of the gaming system 100 is shown as a separate and distinct element connected via a communications network 110, some of functions discussed herein as being performed by one component may be performed by other components. For example, the gaming servers 102 may also be configured to gather and store biometric data, record and store online gaming activity, transfer shared files between player accounts, etc. The components shown may all be contained in one device, but some, or all, may be included in, or performed by multiple devices, or other configurations not shown.

Furthermore, the gaming system 100 may be implemented as software, hardware, any combination thereof, or other forms not listed. For example, any of the network components (e.g., the gaming servers 102, community servers 104, account servers 106, client devices 108, etc.) may include hardware and machine-readable media including instructions for performing the operations described herein. Machine-readable media includes any mechanism that provides (i.e., stores and/or transmits) information in a form readable by a machine (e.g., a gaming machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

Thus, in some embodiments, the clients 108 may be dedicated gaming devices such as a gaming device provided in a casino. The gaming device may execute the gaming computer code locally or the gaming device may be a thought of as a node on a network where one or more servers (which may be local or remote) may execute code and the video signal may be communicated to the gaming device. In other embodiments, the gaming device may be a computing device in a user's home such as a personal computer. The processor in the computing device may be physically configured to execute the code or the personal computer. In other embodiments, the computing device may be thought of as a node on a network where a server is physically configured according to the gaming computing instructions. In yet another embodiment, the gaming device may be a portable computing device. The portable computing device may be physically configured to execute the gaming code or the portable computing device may be in communication with a server that executes some or all of the gaming code and communicates images to be displayed. In all the embodiments, the gaming device may communicate with a central authority that may track game play, awards, likes, dislikes, etc., assuming sufficient permission is obtained. The communication may be wired or wireless and the communication may be secured in a manner to ensure the integrity of the game and the player private information is maintained. In addition, the game may operate on a variety of platforms, from an operating system on a PC to a social media application on a portable computing device platform, to a gaming console platform.

### Gaming Servers

As shown in FIG. 1, the gaming system 100 includes one or more gaming servers 102 which are managed or operated by gaming service providers and configured to enable registered players or registrants to participate in any one or more of a variety of gaming services over the one or more networks 110 provided. Accordingly, the gaming servers 102 may be configured to manage a plurality of databases including, for example, a registrant database and a gaming service database, among other things. Moreover, as is generally held in the art, each gaming server 102 may include one or more computational devices 112 having at least one processor 114 and at least one memory 116 for storing instructions configured to cause the one or more processors 114 of the gaming server 102 to perform one or more preprogrammed functions or operations.

The one or more gaming servers may be located proximately to or remotely from the clients 108. When located proximately, such as at a land-based casino location, the one or more gaming servers 102 may be considered to be part of a casino server. Alternatively, when located remotely, the one or more gaming servers 102 may be considered to be an on-line gaming server. Furthermore, the gaming system may include both one or more casino servers and one or more on-line gaming servers.

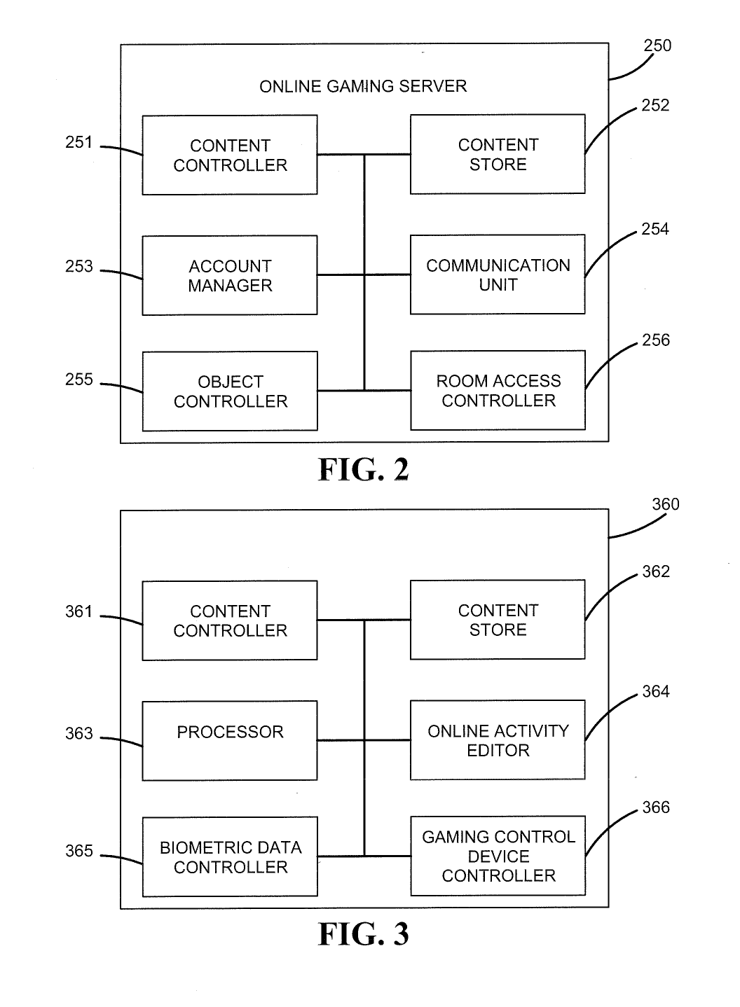

An example of an on-line gaming server 250 is schematically illustrated in greater detail in FIG. 2. The online gaming server 250 may be configured to control wagering game content, provide random numbers, and communicate wagering game information, account information, and other information to and from the clients 108. The online gaming server 250 may include a content controller 251 configured to manage and control content for the presentation of content on the clients 108. For example, the content controller 251 may generate game results (e.g., win/loss values), including win amounts, for games played on the clients 108, and communicate the game results to the clients 108. The content controller 251 may also generate random numbers and provide them to the client 108 so that the clients 108 may generate game results.

The online gaming server 250 may also include a content store 252 configured to contain content to present on the clients 108. The online gaming server 250 may also include an account manager 253 configured to control information related to player accounts. For example, the content controller 251 may communicate wager amounts, game results amounts (e.g., win amounts), award game amounts, etc., to the account server 106. The online gaming server 250 may also include a communication unit 254 configured to communicate information to the clients 108 and to communicate with other systems, devices and networks. For example, the communication unit 254 may track and communicate with community wagering game servers, account servers, community servers, social networking servers, file sharing servers, etc. The online gaming server 250 may also include an object controller 255 configured to control position, movements, actions, functions, etc. of online gaming objects. The online gaming server 250 may also include a room access controller 256 configured to control access to online gaming venue rooms, including security and access levels based on player settings, player status, etc.

### Community Servers/Networks

The community servers 104 of FIG. 1 may be similarly managed or operated by social networks and include virtual communities, public forums, blogs, and the like. Such community servers 104 typically include databases for not only managing the web-based interfaces associated with one or more online communities, but also for managing databases of information pertaining to registrants or members as well as corresponding member profiles, registration information, user preferences, and the like. As with the gaming servers 102, services of the community servers 104 are accessible to registrants via client devices 108 and through the one or more networks 110 interconnecting the client 108 to the community servers 104. Specifically, the network 110 may take the form of a local area network (LAN), a wireless cellular data network, a wide area network (WAN) such as the internet, or any other suitable network or combination of networks enabling local and/or remote communications between the gaming servers 102, community servers 104, account servers 106, and the clients 108.

### Account Servers

The account server 106 may be configured to control user related accounts accessible via wagering game networks, which may include land-based or on-line casino networks and social networks. The account server 106 may store and track player information, such as identifying information (e.g., avatars, screen name, account identification numbers, etc.) or other information like financial account information, social contact information, etc. The account server 106 may contain accounts for social contacts referenced by the player account. The account server 106 may also provide auditing capabilities, according to regulatory rules, and track the performance of players, machines, and servers.

As schematically illustrated in FIG. 1, the account server 106 may include an account controller 130 configured to control information for a player's account, an account store 132 configured to store information for a player's account, and a player preferences settings 134 configured to store settings associated with actions, skins, behaviors, multi-media files, music, and other information with a player account's indicated expressions of emotion, and/or a system imposed expression of an emotion, for an avatar or other object within the online gaming venue. The player preferences settings 134 may communicate information to the object controller 255 to apply the information stored in the settings to an avatar object associated with the player account.

### Client Devices

As depicted in the embodiment of FIG. 1, the client devices or clients 108 may take any one of a plurality of forms including a mobile device, a cellular phone, a smartphone, a tablet device, a laptop computer, a desktop computer, a stationary gaming machine, a portable gaming machine, or any other computational device having at least one input device 118 and at least one output device 120. The input device 118 may include any one or more of a mouse, a keypad, a keyboard, a touchpad, a touchscreen, a microphone, a camera, and any other device enabling the registrant to input information. The output device 120 may include any one or more of a monitor, a display screen, a touchscreen, a speaker, or any other output device enabling a gaming service to be presented to the registrant. The client device 108 also includes one or more processors 122 and at least one memory 124 for storing instructions configured to cause the processor 122 to, among other things, facilitate and/or provide an interface through which a registrant may participate in one or more gaming services sourced by the gaming servers 102 using the input devices 118 and output devices 120. Correspondingly, the client device 108 additionally includes at least one communication device 126, such as a modem, a receiver, a transmitter, a transceiver, a network card, an Ethernet card, or any other communication device having wired and/or wireless connectivity with the gaming servers 102 through the one or more networks 110.

The clients 108 may communicate with external systems (in a wired or wireless manner) such that each client 108 operates as a “thin client,” having relatively less functionality, a “thick client,” having relatively more functionality, or through any range of functionality therebetween (e.g., a “rich client”). When configured as a “thin client,” the client 108 may operate primarily as a display device to display the results of gaming outcomes processed externally, for example, on a server, which may be an external computing device or a “cloud” of computing devices that communicate and work together. In this “thin client” configuration, the external server executes game code and determines game outcomes (e.g., with a random number generator), while a controller on board the client 108 processes display information to be displayed on the display(s) 120.

In an alternative “rich client” configuration, the external server may determine game outcomes while the controller on board the client 108 executes game code and processes display information to be displayed on the display(s) 120. In yet another alternative “thick client” configuration, a controller on board the client 108 executes game code, determines game outcomes, and processes display information to be displayed on the display(s) 120. Numerous alternative configurations are possible such that the aforementioned and other functions may be performed onboard or external to the client 108 as may be necessary for particular applications. It should be understood that the clients 108 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

An embodiment of a client 108 is schematically illustrated as a computational device 360 in FIG. 3. The computational device 360 may be configured to present wagering games and receive and transmit information to control and present online wagering games. The computational device 360 may include a content controller 361 configured to manage and control content and presentation of online gaming venue content on the computational device 360. The computational device 360 may also include a content store 362 configured to contain content to present on the computer system 360. The computational device 360 may also include a processor 363 configured to process wagering game content, present online wagering game objects, control gaming devices, etc.

The computational device 360 may also include an online activity editor 364 configured to record, modify, and share recorded online gaming activity. The online activity editor 364 may be further configured to add comments, text, pictures and other multi-media modifications to the recorded online gaming activity files. The online activity editor 364 may share the recorded online gaming activity with other player accounts. The computational device 360 may also include a biometric data controller 365 configured to detect biometric data from one or more sensors and equipment attached to the computational device and transfer the data to the object controller to express one or more indications of emotions by a player account. The computer system 360 may also include a gaming control device controller 366 configured to detect and control devices, including a gaming pad, custom player control devices, login devices, etc. The gaming pad, for example, may be configured to move an avatar within the online gaming venue in a very fluid motion, much more fluidly than possible with a standard keyboard.

### Casino Gaming Machine

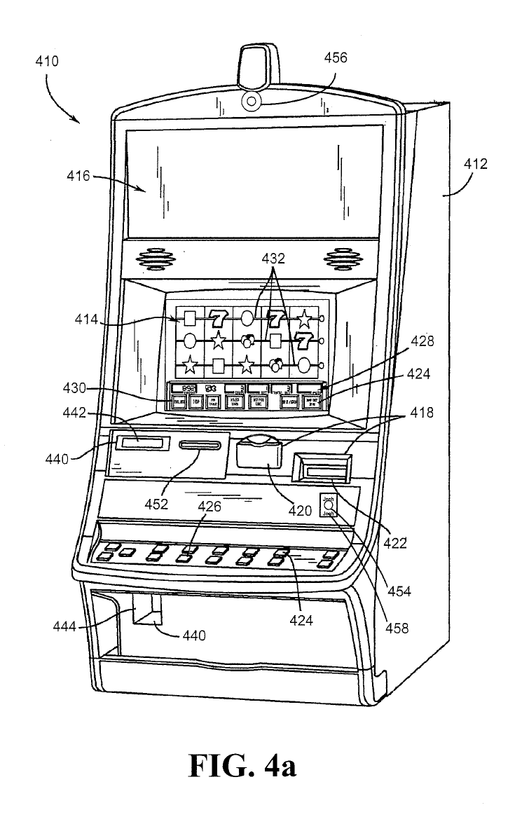

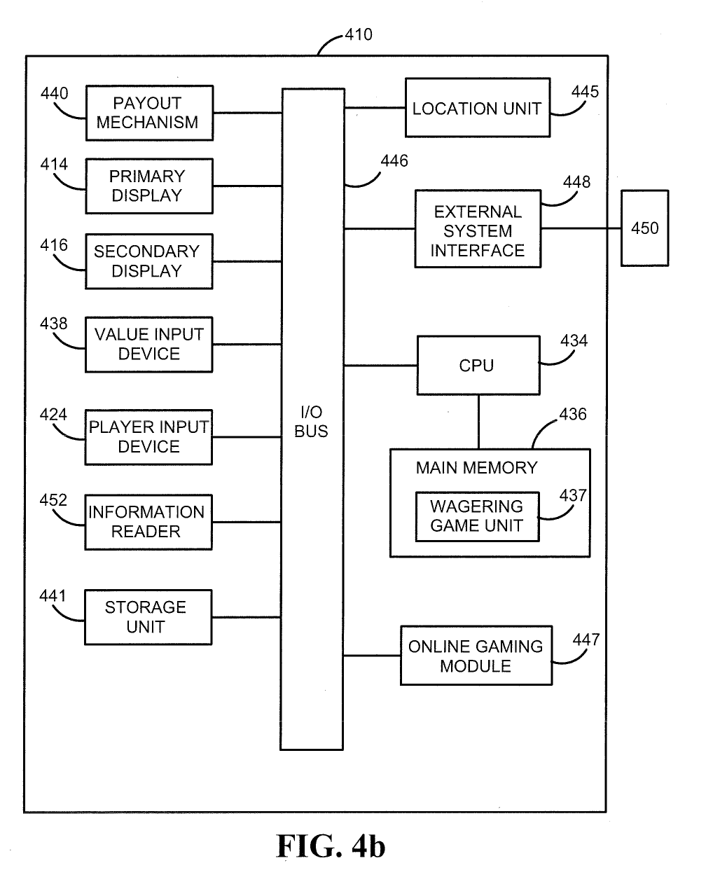

One type of client 108 may be a gaming machine 410 configured for use in a gaming establishment such as a casino, as illustrated in FIGS. 4a and 4b. The gaming machine 410 may be any type of gaming machine and may have varying structures and methods of operation. For example, the gaming machine 410 may be an electromechanical gaming machine configured to play mechanical slots, or it may be an electronic gaming machine configured to play a video casino game, such as slots, keno, poker, blackjack, roulette, etc.

The gaming machine 410 may include a housing 412 and may include input devices, including a value input device 418 and a player input device 424. For output, the gaming machine 410 may include a primary display 414 for displaying information about the wagering game. The primary display 414 may also display information about an award wagering game and a progressive wagering game. The gaming machine 410 may also include a secondary display 416 for displaying game events, game outcomes, and/or signage information. While these typical components found in the gaming machine 410 are described below, it should be understood that numerous other elements may exist and may be used in any number of combinations to create various forms of a gaming machine 410.

The value input device 418 may be provided in many forms, individually or in combination, and is preferably located on the front of the housing 412. The value input device 418 may receive currency and/or credits that may be inserted by a player. The value input device 418 may include a coin acceptor 420 for receiving coin currency (see FIG. 4a). Alternatively, or in addition, the value input device 418 may include a bill acceptor 422 for receiving paper currency. Furthermore, the value input device 418 may include a ticket reader, or barcode scanner, for reading information stored on a credit ticket, a card, or other tangible portable credit storage device. The credit ticket or card may also authorize access to a central account, which can transfer money to the gaming machine 410.

The player input device 424 may include a plurality of push buttons 426 on a button panel for operating the gaming machine 410. In addition, or alternatively, the player input device 424 may include a touch screen 428 mounted by adhesive, tape, or the like over the primary display 414 and/or secondary display 416. The touch screen 428 may include soft touch keys 430 denoted by graphics on the underlying primary display 414 and may be used to operate the gaming machine 410. The touch screen 428 may provide players with an alternative method of input. A player may enable a desired function either by touching the touch screen 428 at an appropriate touch key 430 or by pressing an appropriate push button 426 on the button panel. The touch keys 430 may be used to implement the same functions as push buttons 426. Alternatively, the push buttons 426 may provide inputs for one aspect of operating the game, while the touch keys 430 may allow for input needed for another aspect of the game. In some embodiments, a physical player sensor 456 may also be included. The physical player sensor 456 may be a camera or a biometric sensor or a motion detecting device. The physical player sensor 456 may be used to provide inputs to the game, such as images, selection motions, biometric data and other physical information.

The various components of the gaming machine 410 may be connected directly to, or contained within, the housing 412, as shown in FIG. 4a, or may be located outboard of the housing 412 and connected to the housing 412 via a variety of different wired or wireless connection methods. Thus, the gaming machine 410 may include these components whether housed in the housing 412, or outboard of the housing 412 and connected remotely.

The operation of the basic wagering game may be displayed to the player on the primary display 414. The primary display 414 may also display the award game associated with the basic wagering game. The primary display 414 may take the form of a cathode ray tube (CRT), a high resolution LCD, a plasma display, an LED, or any other type of display suitable for use in the gaming machine 410. As shown, the primary display 414 may include the touch screen 428 overlaying the entire display (or a portion thereof) to allow players to make game-related selections. Alternatively, the primary display 414 of the gaming machine 410 may include a number of mechanical reels to display the outcome in visual association with at least one payline 432. In the illustrated embodiment, the gaming machine 410 is an “upright” version in which the primary display 414 is oriented vertically relative to the player. Alternatively, the gaming machine may be a “slant-top” version in which the primary display 414 may be slanted at about a thirty-degree angle toward the player of the gaming machine 410.

A player may begin play of the basic wagering game by making a wager via the value input device 418 of the gaming machine 410. The value wagered may have a real money value or may be a virtual value that is not redeemable in cash. A player may select play by using the player input device 424, via the buttons 426 or the touch screen keys 430. The basic game may include of a plurality of symbols arranged in an array, and may include at least one payline 432 that indicates one or more outcomes of the basic game. Such outcomes may be randomly selected in response to the wagering input by the player. At least one of the plurality of randomly-selected outcomes may be a start-award outcome, which may include any variations of symbols or symbol combinations triggering a award game.

In some embodiments, the gaming machine 410 may also include a player information reader 452 that allows for identification of a player by reading a card 454 with player information 458 indicating his or her true identity. The player information reader 452 is shown in FIG. 4a as a card reader, but may take on many forms including a ticket reader, bar code scanner, RFID transceiver or computer readable storage medium interface. Currently, identification 458 may be generally used by casinos for rewarding certain players with complimentary services or special offers. For example, a player may be enrolled in the gaming establishment's loyalty club and may be awarded certain complimentary services as that player collects points in his or her player-tracking account. The player may insert his or her card 454 into the player information reader 452, which allows the casino's computers to register that player's wagering at the gaming machine 410. The gaming machine 410 may use the secondary display 416 or other dedicated player-tracking display for providing the player with information about his or her account or other player-specific information. Also, in some embodiments, the information reader 452 may be used to recall or restore game assets that the player achieved and saved during a previous game session either in the gaming establishment or on a separate computing device at a different location.

Turning now to FIG. 4b, the various components of the gaming machine 410 may be controlled by a central processing unit (CPU) 434, also referred to herein as a controller or processor (such as a microcontroller or microprocessor). The controller 434 may include any suitable processor, such as an Intel® Pentium processor, Intel® Core 2 Duo processor, AMD Opteron™ processor, or UltraSPARC processor. To provide gaming functions, the controller 434 may execute (or be physically configured according to) one or more game programs stored in a computer readable storage medium, in the form of a main memory 436. The main memory 436 may include a volatile memory (e.g., a random-access memory (RAM)) and a non-volatile memory (e.g., an EEPROM). The main memory 436 may include multiple RAM and multiple program memories. The main memory 436 may further include a wagering game unit 437. In some embodiments, the wagering game unit 437 may present wagering games having a casino game format, such as video poker, video black jack, video slots, video lottery, reel slots, etc., in whole or in part. Alternatively, the wagering games may be in a casual or social game format, as described in greater detail below.

The controller 434 may perform the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It may be appreciated that the controller 434 may include one or more microprocessors, including but not limited to a master processor, a slave processor, and a secondary or parallel processor.

The controller 434 may also be coupled to a value input device 438. The value input device 438 may signal the processor that money and/or credits have been input via the value input device 418. These components may be located within the housing 412 of the gaming machine 410 or, as explained above, may be located outboard of the housing 412 and connected to the remainder of the components of the gaming machine 410 via a variety of different wired or wireless connection methods.

As seen in FIG. 4b, the controller 434 may be also connected to, and controls, the primary display 414, the player input device 424, a payout mechanism 440, and a storage unit 441. The payout mechanism 440 may be operable in response to instructions from the controller 434 to award a payout to the player in response to certain winning outcomes that might occur in the basic game or the award game(s). The payout may be provided in the form of points, bills, tickets, coupons, cards, etc. For example, in FIG. 4a, the payout mechanism 440 may include both a ticket printer 442 and a coin outlet 444. However, any of a variety of payout mechanisms 440 well known in the art may be implemented, including cards, coins, tickets, smartcards, cash, etc. The payout amounts distributed by the payout mechanism 440 may be determined by one or more pay tables stored in the main memory 436.

An input/output (“I/O”) bus 446 may provide communications between the controller 434 and the peripheral components of the gaming machine. The I/O bus 446 may include any suitable bus technologies, such as an AGTL+ frontside bus and a PCI backside bus. More specifically, the controller 434 may control and receive inputs from the peripheral components of the gaming machine 410 through the I/O bus 446. The I/O bus 446 also may be connected to an external system interface 448, which in turn is connected to external systems 450. The external systems 450 may include a gaming network, other gaming machines, a gaming server, communications hardware, or a variety of other interfaced systems or components. The controller 434 may communicate with the external systems 450 via the external system interface 448 and a communication path (e.g., serial, parallel, IR, RC, 10bT, etc.) The external system interface 448 may include logic for exchanging information over wired and wireless networks (e.g., 802.11g transceiver, Bluetooth transceiver, Ethernet transceiver, etc.). Although the I/O bus 446 and external system interface 448 may be illustrated as single blocks, it should be appreciated that each may include a number of different types of I/O circuits.

The I/O bus 446 further may be connected to a location unit 445. The location unit 445 may create player information that indicates the wagering game machine's location/movements in a casino. In some embodiments, the location unit 445 includes a global positioning system (GPS) receiver that can determine the wagering game machine's location using GPS satellites. In other embodiments, the location unit 445 may include a radio frequency identification (RFID) tag that can determine the wagering game machine's location using RFID readers positioned throughout a casino. Some embodiments can use GPS receivers and RFID tags in combination, while other embodiments may use other suitable methods for determining the wagering game machine's location. Although not shown in FIG. 4b, in some embodiments the location unit 445 is not connected to the I/O bus 446.

In some embodiments, the wagering game machine 410 may include an online gaming module 447. The online gaming module 447 may process communications, commands, or other information, where the processing may control and present online wagering games.

Controller 434, as used herein, may include any combination of hardware, software, and/or firmware that may be disposed or resident inside and/or outside of the gaming machine 410 that may communicate with and/or control the transfer of data between the gaming machine 410 and a bus, another computer, processor, or device and/or a service and/or a network. The controller 434 may include one or more controllers or processors. In FIG. 4b, the controller 434 in the gaming machine 410 is depicted as comprising a CPU, but the controller 434 may alternatively include a CPU in combination with other components, such as the I/O bus 446, the external system interface 448, and the main memory 436. The controller 434 may reside partially or entirely inside or outside of the machine 410. The control system for a handheld gaming machine (disclosed below) may be similar to the control system for the free standing gaming machine 410 except that the functionality of the respective on-board controllers may vary.

### Mobile Gaming Machine

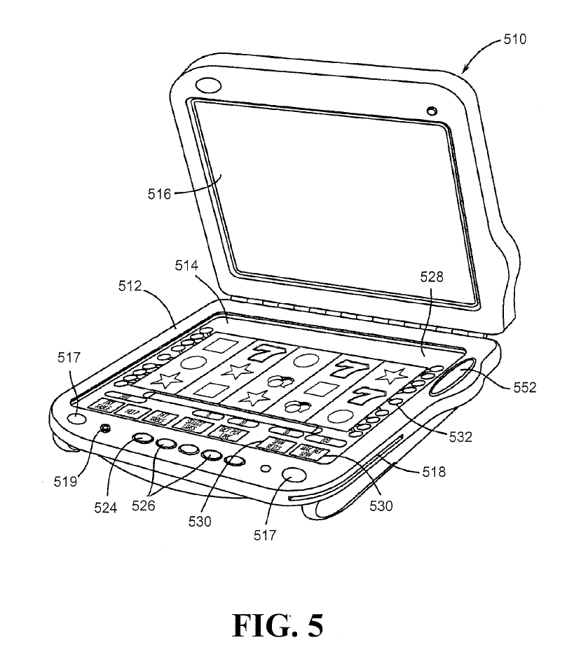

Another type of client 108 may be a handheld or mobile gaming machine 510, illustrated in FIG. 5. Like the free standing gaming machine 410, the handheld gaming machine 510 may be an electronic gaming machine configured to play a casino game such as, but not limited to, slots, keno, poker, blackjack, and roulette. The handheld gaming machine 510 may include a housing or casing 512 and may include input devices, including a value input device 518 and a player input device 524. For output, the handheld gaming machine 510 may include, but is not limited to, a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the handheld gaming machine 510 may include a secondary display 516 that is rotatable relative to the primary display 514. The optional secondary display 516 may be fixed, movable, and/or detachable/attachable relative to the primary display 514. Either the primary display 514 and/or secondary display 516 may be configured to display any aspect of a wagering game, an award game, a progressive wagering game, a group games, a shared-experience game or event, a game event, a game outcome, scrolling information, text messaging, an emails, an alert or announcement, broadcast information, subscription information, and handheld gaming machine status.

The player-accessible value input device 518 may include, for example, a slot located on the front, side, or top of the casing 512 configured to receive credit from a stored-value card (e.g., casino card, smart card, debit card, credit card, etc.) inserted by a player. In another aspect, the player-accessible value input device 518 may include a sensor (e.g., an RF sensor) configured to sense a signal (e.g., an RF signal) output by a transmitter (e.g., an RF transmitter) carried by a player. The player-accessible value input device 518 may also or alternatively include a ticket reader, or barcode scanner, for reading information stored on a credit ticket, a card, or other tangible portable credit or funds storage device. The credit ticket or card may also authorize access to a central account, which may transfer money to the handheld gaming machine 510.

Still other player-accessible value input devices 518 may require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player may be permitted to access a player's account. As one potential optional security feature, the handheld gaming machine 510 may be configured to permit a player to only access an account the player has specifically set up for the handheld gaming machine 510. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 510.

The player-accessible value input device 518 may itself include or utilize a biometric player information reader which permits the player to access available funds on a player's account, either alone or in combination with another of the aforementioned player-accessible value input devices 518. In an embodiment wherein the player-accessible value input device 518 include a biometric player information reader, transactions such as an input of value to the handheld device, a transfer of value from one player account or source to an account associated with the handheld gaming machine 510, or the execution of another transaction, for example, may all be authorized by a biometric reading, which may include a plurality of biometric readings, from the biometric device.

Alternatively, to enhance security, a transaction may be optionally enabled only by a two-step process in which a secondary source confirms the identity indicated by a primary source. For example, a player-accessible value input device 518 may include a biometric player information reader which may require a confirmatory entry from another biometric player information reader 552, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) may be utilized to provide enhanced security prior to the electronic transfer of any funds. In another aspect, the value input device 518 may be provided remotely from the handheld gaming machine 510.

The player input device 524 may include a plurality of push buttons on a button panel for operating the handheld gaming machine 510. In addition, or alternatively, the player input device 524 may include a touch screen 528 mounted to a primary display 514 and/or secondary display 516. In one aspect, the touch screen 528 may be matched to a display screen having one or more selectable touch keys 530 selectable by a user's touching of the associated area of the screen using a finger or a tool, such as a stylus pointer. A player may enable a desired function either by touching the touch screen 528 at an appropriate touch key 530 or by pressing an appropriate push button 526 on the button panel. The touch keys 530 may be used to implement the same functions as push buttons 526. Alternatively, the push buttons may provide inputs for one aspect of the operating the game, while the touch keys 530 may allow for input needed for another aspect of the game. The various components of the handheld gaming machine 510 may be connected directly to, or contained within, the casing 512, as seen in FIG. 5, or may be located outboard of the casing 512 and connected to the casing 512 via a variety of hardwired (tethered) or wireless connection methods. Thus, the handheld gaming machine 510 may include a single unit or a plurality of interconnected parts (e.g., wireless connections) which may be arranged to suit a player's preferences.

The operation of the basic wagering game on the handheld gaming machine 510 may be displayed to the player on the primary display 514. The primary display 514 may also display the award game associated with the basic wagering game. The primary display 514 may take the form of a high resolution LCD, a plasma display, an LED, or any other type of display suitable for use in the handheld gaming machine 510. In some embodiments, the gaming machine 510 may be provided as a portable phone, portable gaming console, or other specific or multi-purpose hand-held device, in which case the primary display 514 may be the display provided with such a device. The size of the primary display 514 may vary from, for example, about a 2-3″ display to a 15″ or 17″ display. In at least some embodiments, the primary display 514 may be a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 514 and/or secondary display 516 may have a 16:9 aspect ratio or other aspect ratio (e.g., 4:3) and the aspect ratio may be modified depending on the game and use of the device. The primary display 514 and/or secondary display 516 may also each have different resolutions, different color schemes, and different aspect ratios.

As with the free standing gaming machine 410, a player may begin play of the basic wagering game on the handheld gaming machine 510 by making a wager (e.g., via the value input device 518 or an assignment of credits stored on the handheld gaming machine via the touch screen keys 530, player input device 524, or buttons 526) on the handheld gaming machine 510. In at least some aspects, the basic game may include a plurality of symbols arranged in an array, and includes at least one payline 532 that indicates one or more outcomes of the basic game. Such outcomes may be randomly selected in response to the wagering input by the player. At least one of the plurality of randomly selected outcomes may be a start-award outcome, which can include any variations of symbols or symbol combinations triggering a award game.

In some embodiments, the player-accessible value input device 518 of the handheld gaming machine 510 may double as a player information reader 552 that allows for identification of a player by reading a card 354 (FIG. 3) with information indicating the player's identity (e.g., reading a player's credit card, player ID card, smart card, etc.). The player information reader 552 may alternatively or also include a bar code scanner, RFID transceiver or computer readable storage medium interface. In one embodiment, the player information reader 552, shown by way of example in FIG. 5, may include a biometric sensing device.

### Gaming System Security

Security features are advantageously utilized where the gaming machines 410, 510 communicate wirelessly with external systems, such as through wireless local area network (WLAN) technologies, wireless personal area networks (WPAN) technologies, wireless metropolitan area network (WMAN) technologies, wireless wide area network (WWAN) technologies, or other wireless network technologies implemented in accord with related standards or protocols (e.g., the Institute of Electrical and Electronics Engineers (IEEE) 802.11 family of WLAN standards, IEEE 802.11i, IEEE 802.11r (under development), IEEE 802.11w (under development), IEEE 802.15.1 (Bluetooth), IEEE 802.12.3, etc.). For example, a WLAN in accord with at least some aspects of the present concepts may include a robust security network (RSN), a wireless security network that allows the creation of robust security network associations (RSNA) using one or more cryptographic techniques, which provides one system to avoid security vulnerabilities associated with IEEE 802.11 (the Wired Equivalent Privacy (WEP) protocol). Constituent components of the RSN may include, for example, stations (STA) (e.g., wireless endpoint devices such as laptops, wireless handheld devices, cellular phones, handheld gaming machine 510, etc.), access points (AP) (e.g., a network device or devices that allow(s) an STA to communicate wirelessly and to connect to a(nother) network, such as a communication device associated with I/O circuit(s) 448), and authentication servers (AS) (e.g., an external system 450), which provide authentication services to STAs. Information regarding security features for wireless networks may be found, for example, in the National Institute of Standards and Technology (NIST), Technology Administration U.S. Department of Commerce, Special Publication (SP) 800-97, ESTABLISHING WIRELESS ROBUST SECURITY NETWORKS: A GUIDE TO IEEE 802.11, and SP 800-48, WIRELESS NETWORK SECURITY: 802.11, BLUETOOTH AND HANDHELD DEVICES, both of which are incorporated herein by reference in their entirety.

### Client Interface—Registration

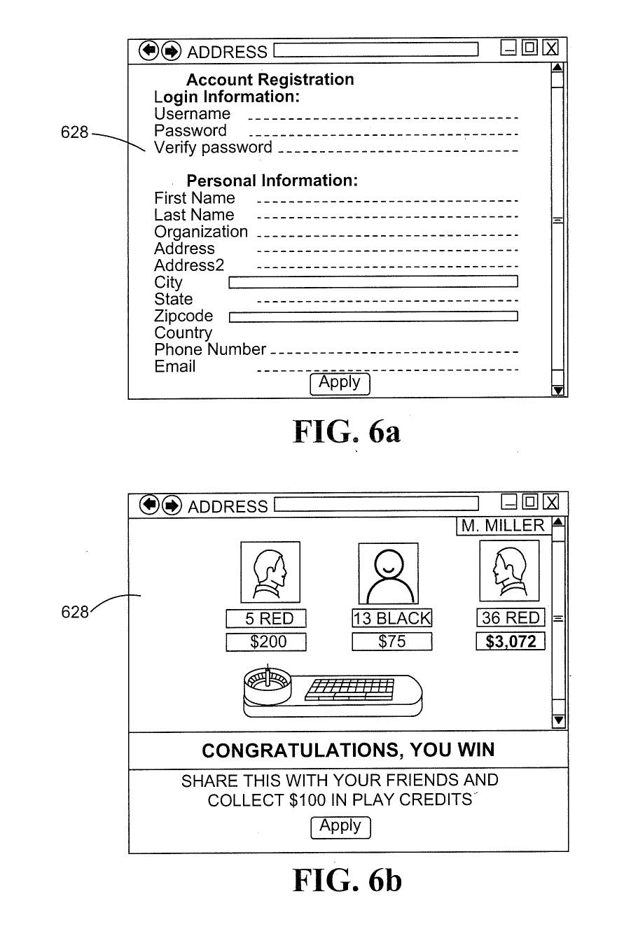

Among other things, the clients 108 may be configured to communicate with the gaming servers 102 to retrieve gaming service data, display gaming service data, operate a gaming service on the client devices 108, and communicate any relevant input provided by the registrant and received through the one or more input devices 118 back to the gaming servers 102. Gaming service data may be initially retrieved from the gaming servers 102 by request of the registrant at the client 108. Specifically, the registrant can initiate the request by navigating a web browser, or the like, within the client device 108 to one or more network or internet addresses associated with and/or managed by the gaming servers 102. Upon receiving the request, the gaming servers 102 communicate gaming service data associated with the desired gaming service through the network 110 to be downloaded, installed and executed on the client device 108. The gaming service data may contain information which once downloaded and installed within the client device 108 creates an interface 628, such as the web-based interface shown in FIGS. 6a and 6b, a standalone application-based interface, or the like, that is supported by the operating system of the client device 108, through which the registrant may participate and/or interact with the gaming service.

The interface 628 provided to the registrant via the client 108 can be configured in a number of different ways to facilitate interactions between the registrant and the gaming service. As shown in FIG. 6a for instance, the interface 628 may be used to receive registration information from a new user so as to register the user with one or more gaming services and to store the registrant information in the database or memory 116 associated with the gaming servers 102. More particularly, the interface 628 may be used to gather information such as the registrant's name, mailing address, contact information, electronic mailing address, and the like. The registration interface 628 may also enable the registrant to establish a desired alias, username or login, as well as corresponding passwords or other login credentials.

### Client Interface—Gameplay

In addition, the interface 628 can be used to enable play of a wagering game or otherwise facilitate registrant participation. As noted above, the wagering game may be a game of chance, a contest, a social (i.e., “play-for-fun”) game, a sweepstake, or other gaming content provided by the gaming servers 102, as shown in FIG. 6b. For example, while displaying images, video, audio, and/or any other media pertaining to play of a wagering game, the interface 628 may also be configured to receive various inputs from the registrant during gameplay. Based on the type of client device 108 being used and the types of input devices 118 available to the player, for example, the player may provide game input using actions such as mouse-clicks, keystrokes, mouse gestures, finger or hand gestures, voice commands, and the like. Such player input is read by the client device 108 and used to determine the corresponding actions and/or selections that are desired by the player. The relevant actions and/or selections can then be communicated to the respective gaming servers 102 in a manner which enables the player to gain entry into contests or sweepstakes, advance through levels or stages of a game of chance, acquire cash-redeemable credits or virtual currency, rewards, points, and the like.

### Player Accounts

Player accounts may be used to store, track, and update information associated with registered players of the wagering game. Each registered player may have an associated player account. For example, a first player account may be associated with a first player, a second player account may be associated with a second player, and so on. Each player account may include account information associated with a respective registered player. In addition to the player information noted above, each player account may include additional information related to play of the wagering game, such as information indicative of an amount of money, virtual currency, or other assets attributed to the player associated with the player account. The assets may be configured for use in the wagering game or other games. For example, the player account may include a real credit balance indicative of real credits available for wagering in a casino-style wagering game, a virtual credit balance indicative of an amount of virtual credits available for wagering in a social/casual type wagering game, and/or other account information that tracks other assets or attributes that may be used in the casino, social/casual, or other type of wagering game. The player accounts may be stored on a remote server, such as the account server 106. Alternatively, the player accounts may be stored locally, such as on a gaming device 410, 510, stationary or portable PC, on-site server (e.g., a casino server), or other computational device 360.

### Rewarding Player Referrals in a Wagering Game

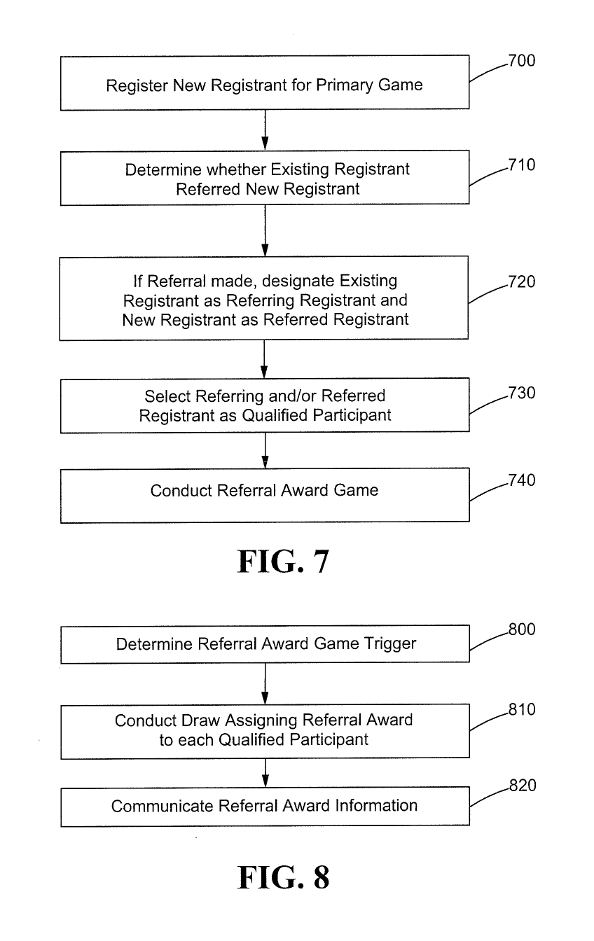

FIG. 7 may illustrate a method of awarding a bonus to a player accessing wagering game content on a computational device 360. At block 700, a new player may be registered to access a primary wagering game. During registration, the new player may enter personal information to create a new player profile. The new player information may be input using the inputs 118 of a client device 108. The new player information may be stored locally, such as on the gaming machine 410 or 510 or on a casino server provided on site, or remotely, such as on the account server 106. The primary wagering game may be accessible from a real world or on-line casino, a social website, or other wagering game content provider.

At block 710, it may be determined whether the new registrant was referred by an existing registrant for the primary wagering game. The presence of a referral relationship between the new registrant and the existing registrant may be determined in a variety of manners. For example, the new registrant may be prompted to enter information regarding an existing registrant that referred him/her to access the primary wagering game. Alternatively, the primary wagering game may facilitate referrals by allowing existing registrants to send invitations to potential new registrants. The invitations may be sent electronically and include embedded code that identifies the presence of the referral, and may include information that identifies the existing registrant as the source of the referral. Various other methods may be used to determine whether an existing registrant referred the new registrant to access the primary wagering game.

At block 720, if it is determined that a referral was made by the existing registrant to the new registrant, then the existing and new registrants may be designated in a manner that identifies the presence of the referral between the two. For example, the existing registrant may be designated as a referring registrant to indicate that the existing registrant referred a player to the primary wagering game that subsequently registered to play the game. Similarly, the new registrant may be designated as a referred registrant to indicate that the new registrant was referred by an existing player of the primary wagering game. The designations assigned to the existing and new registrants indicate that a referral was initiated by the existing registrant and completed by the new registrant when he/she registered to play the primary wagering game.

At block 730, at least one of the referring registrant and the referred registrant is selected as a qualified participant in a referral award game. For example, participation in the referral award game may be restricted to only referring registrants. Alternatively, participation may be restricted to only referred registrants. Still further, both referring and referred registrants may participate in the referral award game. Accordingly, the execution of a referral to induce a new player to register for the primary wagering game may be considered a qualifying event for the referral award game, and participation in the referral award game may be open to only referred registrants, only referring registrants, or both referred and referring registrants.

At block 740, the referral award game is conducted. As noted above, participation in the referral award game may be limited to registrants that have either made or received a referral to play the primary wagering game. The referral award game provides incentive for referrals by providing a referral award to each qualified participant.

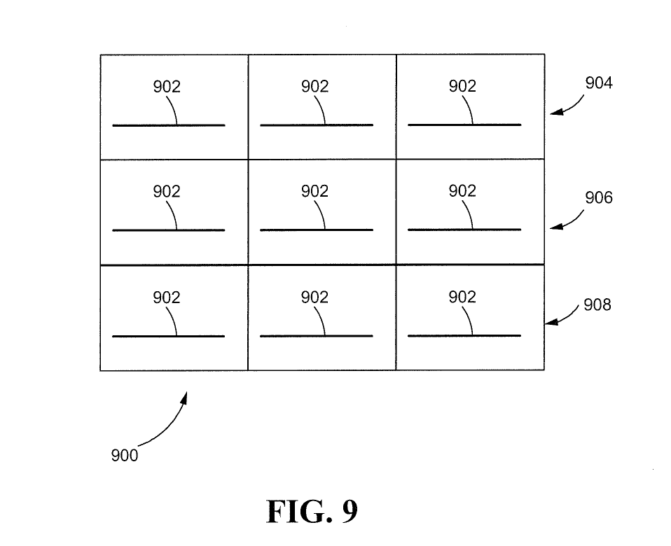

FIG. 8 may illustrate a method for conducting the referral award game. At block 800, a referral award game trigger for initiating the referral award game may be determined. In general, the referral award game trigger may be a capacity or threshold which, when met, will start the referral award game. The referral award game trigger may be a maximum capacity of qualified participants which, when reached, will initiate the referral award game. An example of a referral award game 900 having a maximum capacity is schematically illustrated in FIG. 9. The referral award game 900 may include a finite number of entry slots 902 arranged in a three-by-three grid. In the illustrated example, the referral award game 900 has a total of nine entry slots 902, however the number of entry slots 902 may be greater or smaller than nine. A qualified participant may be assigned to each entry slot 902. As shown in FIG. 9, information identifying a qualified participant, such as a name of the qualified participant, may be assigned to each entry slot 902. When the maximum capacity is reached, a separate referral award game may be started having open entry slots for additional qualified participants.

Instead of a maximum capacity, the referral award game trigger may be time based. For example, the referral award game trigger may be a set time, such as a specific date and time, at which the referral award game will continue. Alternatively, the referral award game trigger may specify a period of time, such as a day, week, or month, from the time of the referral, after which the referral award game will advance.

As a further alternative, the referral award game trigger may be based on subsequent play of the one or more qualified participants. For example, the referral award game trigger may be a specifically defined achievement, such as a threshold amount of play time of the primary wagering game, a threshold amount of account deposits, a threshold number of qualified participants, obtaining a specific primary wagering game result, or other type of achievement. The specifically defined achievement may be an individual achievement based on the actions of a single qualified participant, or may be a group achievement based on an aggregate of the actions of a defined referral group of qualified participants.

Returning to FIG. 8, the referral award game may continue at block 810 by conducting a draw that assigns a referral award to each qualified participant. In the referral award game 900 illustrated in FIG. 9, for example, the draw may randomly map specific referral awards to each entry slot 902 that are then usable by the qualified participant associated with each slot. The referral awards may be usable in the primary wagering game, a secondary wagering game, or both the primary and secondary wagering games. Depending on the formats of the primary and secondary games, each referral award may have a monetary value component, a virtual value component, or a combination of both monetary and virtual value components. The monetary value component may be redeemable for cash, while the virtual value component may have a non-cash value that is otherwise usable in the primary or secondary wagering game.

In some embodiments, the referral award may have a monetary value component that is predetermined, such as a fixed dollar amount. In the embodiment of FIG. 9, for example, the fixed dollar amounts may be distributed as follows: five of the entry slots 902 may be assigned $10; three of the entry slots 902 may be assigned $15; and one of the entry slots 902 may be assigned $20. The foregoing values and distribution of fixed dollar amounts are merely provided as an example, as other values and distributions may be used.

In some embodiments, the monetary value component of the referral award may be a modifying factor that is applied to store of value associated with the qualified participant. For example, the qualified participant may have a wagering account that is associated with the primary wagering game, and the modifying factor may be a deposit multiplier applicable to an amount of a deposit made into the wagering account. The deposit multiplier may be identified as a percentage, a multiplication value, or other factor which indicates the amount by which the deposit amount is increased. The deposit multiplier mapped to each entry slot 902 may be the same or different for a given referral award game. If different deposit multipliers are used, each deposit multiplier may be selected from specific, predetermined factors, or may be selected from a predetermined range of factors. For example, the range of multipliers may be 5-10%, and a specific deposit multiplier from within the range may be randomly assigned to each entry slot 902.

The deposit to which the multiplier applies may be made either prior or subsequent to the draw. If applied to a deposit made prior to the draw, each qualified participant may be notified of the actual deposit multiplier assigned to his/her associated entry slot 902. Alternatively, if the deposit multiplier is to be applied to a deposit made after the draw, the actual deposit multiplier may be withheld from the qualified participant until the subsequent deposit is made.

Use of the monetary value component of the referral award may be unrestricted or may have restrictions. If unrestricted, the monetary value component may have a cash equivalent that may immediately withdrawn from the wagering account of the qualified participant. Otherwise, restrictions may be imposed as to how the monetary value component may be used. For example, the monetary value component may be a “playable balance,” where initially the monetary value component may only be used in connection with a wagering game. As all or a portion of the monetary value component is used in the wagering game, it may be gradually or immediately converted into a withdrawable balance that may be transferred out of the wagering account. In yet other embodiments, some of the referral awards may be unrestricted while other referral awards determined in the same referral award game may be restricted.

Referring back to FIG. 8, information regarding the referral award may be communicated to each qualified participant at block 820. The communication of referral award information may be provided prior to the draw, such as by inviting the qualified participants to view a live draw event. For example, in the referral award game 900 illustrated in FIG. 9, the results of the draw may be revealed in a manner similar to a slot machine, where virtual spinning reels may be stopped to show the referral award assigned to each associated entry slot 902 on the three-by-three grid. Alternatively, the communication of referral award information may be made subsequent to the draw. The referral award information may include the specific results of the referral award game, such as the actual monetary value component awarded to the qualified participant. Still further, the referral award information may omit the results and instead provide general information, such as identifying the specific referral game for which the registrant is a qualified participant and/or indicating that a draw has concluded. If only general information is provided, the qualified participant may be prompted to access the results of the referral award game through the wagering account, primary or secondary wagering game, or other means.

In some embodiments, the referral award game may be configured to augment the referral award based on achievements within the referral award game itself. For example, an augment award may be determined when predetermined portions of the total number of available entry slots of a referral award game are filled with qualified participants. Referring to FIG. 9, the three-by-three grid may include first, second, and third tiers 904, 906, 908 of entry slots 902. In the illustrated embodiment, each tier 904, 906, 908 includes three available entry slots 902, however each tier may include more or less than three slots. Furthermore, each tier 904, 906, 908 may have a different number of slots associated therewith. The entry slots 902 may be filled in the order of the tiers, so that qualified participants are first assigned to available entry slots 902 in the first tier 904. Once the entry slots 902 of the first tier 904 are filled, the qualified participants are then assigned to available entry slots 902 in the second tier 906. Finally, once the first and second tiers 904, 906 are complete, the qualified participants are assigned to available entry slots 902 in the third tier 908.

An augment award may be determined at the completion of each tier 904, 906, 908. For example, a first tier augment award may be determined when the entry slots 902 of the first tier 904 are completely filled. Similarly, second and third tier augment awards may be determined when the second and third tiers 906, 908, respectively, are completed. Each of the first, second, and third tier augment awards may add an augment award value to the referral award. For example, if the referral award includes a fixed monetary value, the augment award value may be an additional fixed monetary value. Alternatively, if the referral award includes a modifying factor (such as a deposit multiplier), the augment award value may be an additional multiplier that is added to the modifying factor.

In some embodiments, the augment award value may be graduated, based on the level of the competed tier. For example, the augment award for completion of the first tier 904 may in a first augment award range, such as 1-3 times a fixed monetary value or a multiplier of 1-3%. A second augment award range for completion of the second tier 906 may be 3-7 times a fixed monetary value or a multiplier of 3-7%. Similarly, the augment award for completion of the third tier 908 may be 7-15 times a fixed monetary value or a multiplier of 7-15%.

In some embodiments, instead of being achievement-based, a qualified participant may purchase an augment award. Prior to revealing the referral award assigned by the draw, a qualified participant may transfer a pre-determined augment purchase amount in exchange for an augment award. The augment award may be a pre-determined or random award that may increase or decrease the referral award. For example, the augment award may be an additional multiplier randomly selected from a range of −3% to +3%. Accordingly, a negative additional multiplier may reduce the monetary value of the referral award, an additional multiplier of zero may not alter the monetary value of the referral award, and a positive additional multiplier may increase the monetary value of the referral award.

In some embodiments, the augment award may modify the referral award determined by the referral award game. For example, the referral award may normally be a playable balance that may not be immediately withdrawn. However, upon reaching achievements in the referral award game, such as completing one or more tiers of entry slots 902, the referral award may be gradually or completely converted into a withdrawable balance. Alternatively, the referral award may be a playable balance requiring a number of play-throughs, and the number of play-throughs may be reduced as achievements in the referral award game are met.

In some embodiments, the augment award may have no monetary value. For example, the augment award may be a virtual currency benefit that is usable on social or casual game. Accordingly, the virtual currency benefit may be a bonus game, bonus mechanic, bonus item, or virtual credits that may be used in the social game. In one embodiment, the social game may be a virtual horse-racing game, in which a registrant is associated with a virtual horse having virtual attributes such as power, endurance, and tactical speed. The virtual currency benefit may be a virtual credit that may be used to increase one or more of the virtual attributes.

In some embodiments, the relationship between the referring registrant and the referred registrant may continue after the referral award game. For example, a referral group may be determined that includes a number of referring and/or referred registrants. The referral group may be based on pre-existing relationships, which may be evidenced by a referring-referred relationship between two registrants. The use of pre-existing relationships may also serve to validate the results of the draw, as specific award amounts may be verified through subsequent communications between the registrants, possibly even outside of the gaming system. Alternatively, the referral group may be determined by other factors, such as registrants that qualified as participants in a common referral award game.

Subsequent to the referral award game, additional offers, promotions, or other awards may be provided to the registrants associated with a given referral group. The subsequent awards may be based on subsequent play of the referral group. For example, the entire referral group may receive a subsequent award when one of the registrants associated with that referral group completes a predefined achievement, such as a threshold amount of game time, a threshold amount of gameplay, or a major jackpot. In some embodiments, a subsequent award may be determined based on the performance of referral group relative to other referral groups. A subsequent award may be provided to a referral group achieving specific performance thresholds, such as a referral group that wagers an aggregate amount ranking in the top 5% of all referral groups. Information indicating the performance of referral groups may be tracked and displayed, such as on a leaderboard, to promote competition between referral groups. In other embodiments, a subsequent award may be based on an absolute, rather than a relative, achievement of the referral group. For example, the referral group may receive a number of entries in a subsequent award game that is commensurate with an aggregate sum wagered by the group over a predetermined period, thereby increasing the amount of the subsequent award provided to the referral group. The predetermined period may be weekly, monthly, or any other measure of time.

The primary wagering game, referral award game, and secondary wagering game may have any one of various game formats. Examples of game formats may include a cash value wagering game format, in which a monetary value may be wagered, and a virtual value wagering game format, in which the wagering game may be played for free or with virtual currency (i.e., a “play-for-fun” game format commonly provided on social websites). In the systems and methods disclosed herein, each of the primary wagering game, referral award game, and secondary wagering game may be presented in any one of the game formats.

Additionally, the primary wagering game, referral award game, and secondary wagering game may be conducted at any one of various game venues. Examples of game venues may include a land-based casino, an on-line casino, a social website accessed via a home computer, and an application on a mobile device. In the systems and methods disclosed herein, each of the primary wagering game, referral award game, and secondary wagering game may be conducted in any one of the game venues.

FIGS. 6-8, described by way of example above, represent algorithms that correspond to at least some instructions executed by one of the computational devices illustrated in FIGS. 1-5 to perform the above-described functions associated with the disclosed concepts. Each of these embodiments and obvious variations thereof are contemplated as falling within the spirit and scope of the following claims. Moreover, the present concepts expressly include any and all combinations and sub-combinations of the preceding elements and aspects.

What is claimed is:

1. A computer-implemented method of rewarding player referrals in a primary wagering game, comprising:
registering a new registrant for the primary wagering game through one or more input devices of a computational device;
in response to determining that a referral was made to the new registrant by an existing registrant, designating the new registrant as a referred registrant and the existing registrant as a referring registrant;
selecting at least one of the referred registrant and the referring registrant as a qualified participant for a referral award game;
conducting the referral award game for the at least one qualified participant, the referral award game comprising:
determining a referral award game trigger for initiating the referral award game;
conducting a draw in which a referral award is randomly assigned to each qualified participant, the referral award including a value component usable in at least one of the primary wagering game and a secondary wagering game; and
communicating referral award information to the at least one qualified participant.

2. The computer implemented method of claim 1, in which the primary wagering game is conducted at a first game venue and the secondary wagering game is conducted at a second game venue, and in which the first and second game venues are selected from a group of game venues consisting of a land-based casino, an on-line casino, and a social website.

3. The computer implemented method of claim 1, in which the value component comprises a monetary value component including a deposit multiplier applicable to an amount of a deposit transferred by the at least one qualified participant into a wagering account associated with the at least one qualified participant.

4. The computer implemented method of claim 1, in which the value component comprises a monetary value component including a playable balance.

5. The computer implemented method of claim 1, in which the value component comprises a virtual value component.

6. The computer implemented method of claim 1, in which determining the referral award game trigger comprises determining a maximum capacity of qualified participants for the referral award game.

7. The computer implemented method of claim 6, in which the referral award game further comprises:
arranging the qualified participants into at least a first tier and a second tier; and
determining a first augment award range associated with the first tier and a second augment award range associated with the second tier.

8. The computer implemented method of claim 1, in which determining the referral award game trigger comprises:
determining an achievement threshold associated with the primary wagering game; and
determining whether the at least one qualified participant has met the achievement threshold.

9. The computer implemented method of claim 1, in which:
both the referring registrant and the referred registrant are selected as qualified participants; and
the referral award game further comprises determining a referral group including the referring registrant and the referred registrant.

10. The computer implemented method of claim 1, in which the referral award game further comprises:
determining an award game participation threshold associated with the referral award game;
determining a referral game participation award when the award game participation threshold is met; and
determining a virtual value component of the referral award.

11. A gaming system comprising a processor, a memory, in communication with the processor, a display, and an input/output circuit, the processor being physically configured according to computer executable instructions for rewarding player referrals in a primary wagering game, the computer executable instructions comprising instructions for:
registering a new registrant for the primary wagering game through one or more input devices of a computational device;
in response to determining that a referral was made to the new registrant by an existing registrant, designating the new registrant as a referred registrant and the existing registrant as a referring registrant;
selecting at least one of the referred registrant and the referring registrant as a qualified participant for a referral award game;
conducting the referral award game for the at least one qualified participant, the referral award game comprising:
determining a referral award game trigger for initiating the referral award game;
conducting a draw in which a referral award is randomly assigned to each qualified participant, the referral award including a value component usable in at least one of the primary wagering game and a secondary wagering game; and
communicating referral award information to the at least one qualified participant.

12. The gaming system of claim 11, in which the value component comprises a monetary value component including a deposit multiplier applicable to an amount of a deposit transferred by the at least one qualified participant into a wagering account associated with the at least one qualified participant.

13. The gaming system of claim 11, in which the value component comprises a virtual value component.

14. The gaming system of claim 11, in which determining the referral award game trigger comprises:
determining an achievement threshold associated with the primary wagering game; and
determining whether the at least one qualified participant has met the achievement threshold.

15. The gaming system of claim 11, in which:
both the referring registrant and the referred registrant are selected as qualified participants; and
the referral award game further comprises determining a referral group including the referring registrant and the referred registrant.

16. A tangible machine-readable storage media including instructions which, when executed by one or more processors, cause the one or more processors to perform operations comprising:
registering a new registrant for a primary wagering game through one or more input devices of a computational device;
in response to determining that a referral was made to the new registrant by an existing registrant, designating the new registrant as a referred registrant and the existing registrant as a referring registrant;
selecting at least one of the referred registrant and the referring registrant as a qualified participant for a referral award game;
conducting the referral award game for the at least one qualified participant, the referral award game comprising:
determining a referral award game trigger for initiating the referral award game;
conducting a draw in which a referral award is randomly assigned to each qualified participant, the referral award including a value component usable in at least one of the primary wagering game and a secondary wagering game; and
communicating referral award information to the at least one qualified participant.

17. The tangible machine-readable storage media of claim 16, in which the value component comprises a monetary value component including a deposit multiplier applicable to an amount of a deposit transferred by the at least one qualified participant into a wagering account associated with the at least one qualified participant.

18. The tangible machine-readable storage media of claim 16, in which the value component comprises a virtual value component.

19. The tangible machine-readable storage media of claim 16, in which determining the referral award game trigger comprises:
determining an achievement threshold associated with the primary wagering game; and
determining whether the at least one qualified participant has met the achievement threshold.

20. The tangible machine-readable storage media of claim 16, in which:
both the referring registrant and the referred registrant are selected as qualified participants; and
the referral award game further comprises determining a referral group including the referring registrant and the referred registrant.
